(19) United States
(12) Patent Application Publication
(10) Pub. No.: US 2013/0319801 A1
(43) Pub. Date: Dec. 5, 2013

(54) HYDRAULIC BRAKE DEVICE

(71) Applicant: YU-SUNG HUANG, New Taipei City (TW)

(72) Inventor: YU-SUNG HUANG, New Taipei City (TW)

(21) Appl. No.: 13/488,428

(22) Filed: Jun. 4, 2012

(51) Int. Cl. F16D 65/22; F16D 65/847; F16D 55/226

(52) U.S. Cl. 188/72.4

(57) ABSTRACT

A hydraulic brake device includes at least one caliper body that defines a pressure chamber, at least one elastic enclosure member that is arranged inside the caliper body to operate in combination with the pressure chamber and shows a corrugated configuration, and at least one brake pad mounting assembly, which is arranged on the elastic enclosure member at the side away from the pressure chamber. With fluid passages provided in communication with the pressure chamber, hydraulic fluid can be supplied to compress the elastic enclosure member for driving the brake pad mounting assembly and the brake lining assembly to effect braking. The corrugated configuration helps reducing deformational stress induced in the elastic enclosure member and also reducing operation resistance. A ventilation section is also provided on the caliper body to draw in fresh air for heat dissipating purposes.

### TECHNICAL FIELD OF THE INVENTION

The present invention generally relates to a hydraulic brake device, and more particularly to a hydraulic brake device that uses combined operation of fluid passages, a pressure chamber, and an elastic enclosure member to compress the elastic enclosure member for driving a brake pad mounting assembly to achieve the purposes of braking and improving fluid leakage and also to improve heat dissipation through a ventilation section provided on a caliper body.

### DESCRIPTION OF THE PRIOR ART

FIG. 1 is a schematic view showing a conventional hydraulic brake device, which uses hydraulic fluid to drive pistons 20 and brake pads 21 to tightly clamp a brake disk 22 in order to effect braking. In such a known driving structure of pistons 20, the pistons 20 are constantly set in sliding movement with seal rings 23 and this leads to abrasion and wear. Particularly, the pistons 20 have cylindrical circumferences that carry fluid and such fluid may get out of the pressure chamber through repeated operation, thereby causing fluid leakage. The leakage of fluid of a brake system will lead to malfunctioning of the brake system and this is an intolerable issue of braking.

Further, Taiwan Invention Patent 1353322 that was filed on Jun. 11, 2008 discloses an elastic body that realizes complete enclosure to overcome the fluid leakage issue of the sliding type pistons. However, the elastic body must be made of a soft material, such as soft rubber, to ensure an elastic function of a U-shaped section for driving the brake pads. Rubbers or other materials made through chemical measures suffer common problems of fluid absorption and aging. Particularly, rubber materials must be subjected to modification of composition thereof to alleviate the problems of fluid absorption and heat resistance in order to resist the corrosions (chemical reactions or fluid absorption) caused by the high temperature and hydraulic pressure induced in braking. The manufacture cost will be surely high. This is also a drawback. Particularly, a fixing plate used in the conventional device must be fixed by bolts and the gap around threading is a way of leakage.

In addition, the present inventor was issued Taiwan Utility Model No. M336361 on Jan. 29, 2008. The Utility Model has a feature of an elastic cover in the form of a thin plate. The elastic cover of the prior art reference has a simple structure of bent step or a thin disk of annular configuration, which can overcome the problem of fluid leakage and has an advantage of low-cost high-efficient production through stamping operation. To reduce the deformation resistance of material, the relatively rigid material that was previously used is replaced by a disk-like thin plate having resiliency. With such an arrangement, the thin metal plate is converted into an elastic bowl-shaped plate. It is well known that metal is superior to rubber in respect of chemical resistance and temperature resistance. The design of the prior art reference is superior with respect to even earlier devices.

Through numerous tests and experiments, the present inventor get aware that further improvement can be made, where although bent steps or annual configuration may reduce deformation resistance of material by generating concave or convex deformation on the elastic cover to effect braking, yet there is still residual resistance against deformation that requires additional effort that a rider applies to move a brake level. The operation is thus not good enough for users and further improvement must be made. This application aims to make improvements for such an issue.

### SUMMARY OF THE INVENTION

The primary object of the present invention is to use successive and opposite extended curves of a corrugated elastic enclosure member to form an annular corrugated configuration in order to set more material in such a corrugated configuration for minimizing the ratio of deformation and at the same time reducing deformational stress in order to improve the feeling of hand grip in braking.

Another object of the present invention is to increase the effect of pressurization for a force generated by a hydraulic system is multiplication of force application area on which the pressure of the hydraulic fluid acts and unit pressure, so that an increase of the force application area will increase the force output.

To achieve the above objects, the present invention provides a hydraulic brake device, which comprises at least one caliper body that defines a pressure chamber; at least one elastic enclosure member that is arranged inside the caliper body to operate in combination with the pressure chamber and shows a corrugated configuration, and at least one brake pad mounting assembly, which is arranged on the elastic enclosure member at the side away from the pressure chamber. The caliper body forms therein fluid passages communicating with the pressure chamber. The caliper body comprises a sealing bolt mounted thereto to seal the fluid passages. The caliper body also comprises a threaded enclosure ring that fixes an elastic enclosure member and receives a brake pad mounting assembly therein. At least one sealing component is arranged at one side of the elastic enclosure member and the enclosure ring and at least one sealing ring is arranged at an opposite side.

The brake pad mounting assembly comprises a magnetic permeability section that is mounted to the elastic enclosure member and a magnetic element that is mounted to the magnetic permeability section and is operatively coupled to a brake lining assembly. The brake lining assembly comprises a base and a lining mounted to the base. The base comprises a plurality of heat dissipation sections extending therefrom.

With the above arrangement, the present invention fastens the sealing bolt to the caliper body to form a sealed pressure chamber, in order to prevent fluid leakage and to compress the elastic enclosure member for driving the brake pad mounting assembly to achieve the function of braking. The elastic enclosure member is of a corrugated configuration to reduce deformational stress of the enclosure member of low elasticity material so as to reduce operation resistance and improve fluid leakage. Further, the caliper body is formed with a plurality of vent openings for guiding cold fresh air into the caliper body to achieve heat dissipation purposes.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a conventional hydraulic brake device.

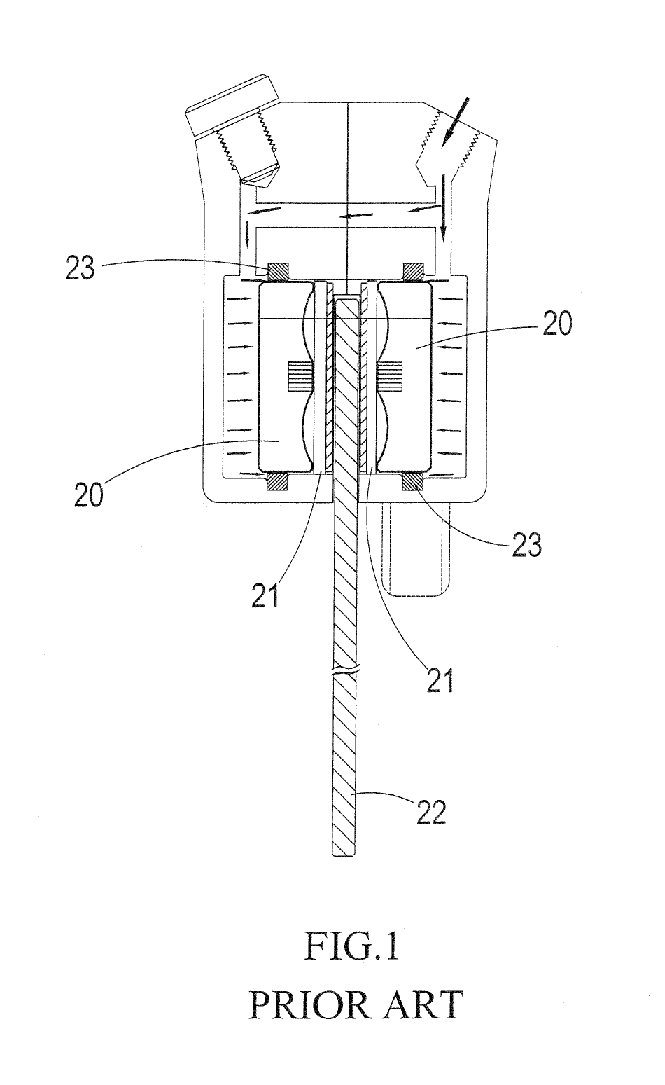

FIG. 2 is a cross-sectional view showing a preferred embodiment of the present invention.

FIG. 3 is a schematic view showing implementation of the preferred embodiment according to the present invention.

FIG. 3A is another schematic view showing implementation of the preferred embodiment according to the present invention.

FIG. 3B is a further schematic view showing implementation of the preferred embodiment according to the present invention.

FIG. 4 is a schematic view showing example implementation of another preferred embodiment according to the present invention.

FIG. 4A is another schematic view showing example implementation of another preferred embodiment according to the present invention.

FIG. 4B is a further schematic view showing example implementation of another preferred embodiment according to the present invention.

FIG. 5 is a schematic view showing implementation of a further preferred embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

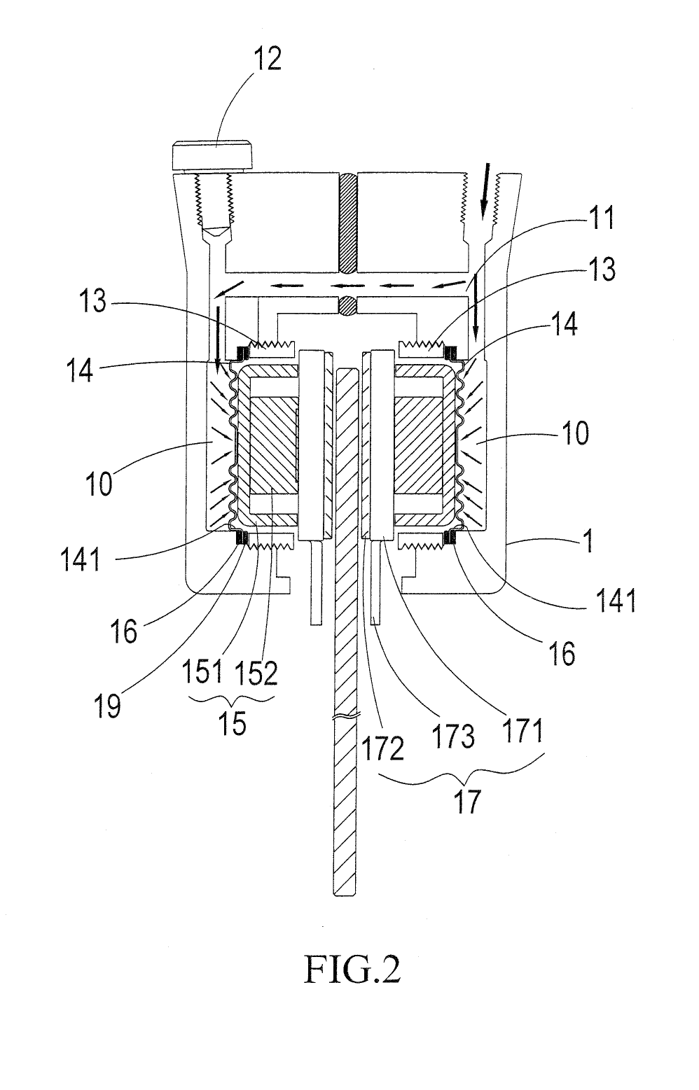

Referring to FIG. 2, which is a cross-sectional view showing a preferred embodiment of the present invention, the drawing clearly shows that the present invention provides a hydraulic brake device, which comprises the following constituent components:

At least one caliper body 1 defines therein a pressure chamber 10. The caliper body 1 also defines therein fluid passages 11 communicating with the pressure chamber 10. The caliper body 1 comprises at least one sealing bolt 12 mounted thereto to seal the fluid passages 11 and a threaded enclosure ring 13 that fixes an elastic enclosure member 14 that will be described hereinafter and receives a brake pad mounting assembly 15 therein.

At least one corrugated elastic enclosure member 14 is arranged inside the caliper body 1 to operate in combination with the pressure chamber 10. At least one sealing component 16 is arranged at one side of the elastic enclosure member 14 and the enclosure ring 13 and at least one sealing ring 19 is arranged at an opposite side. The elastic enclosure member 14 forms a bent rim 141. The elastic enclosure member 14 is made of metal, rubber, or polymer.

At least one brake pad mounting assembly 15 is arranged on the elastic enclosure member 14 at the side away from the pressure chamber 10. The brake pad mounting assembly 15 comprises a magnetic permeability section 151 that is mounted to the elastic enclosure member 14 and a magnetic element 152 that is mounted to the magnetic permeability section 151 and is operatively coupled to a brake lining assembly 17.

The brake lining assembly 17 comprises a base 171 and a lining 172 mounted to the base 171. The base 171 comprises a plurality of heat dissipation sections 173 extending therefrom. The sealing component 16 comprises a sealing adhesive or gasket.

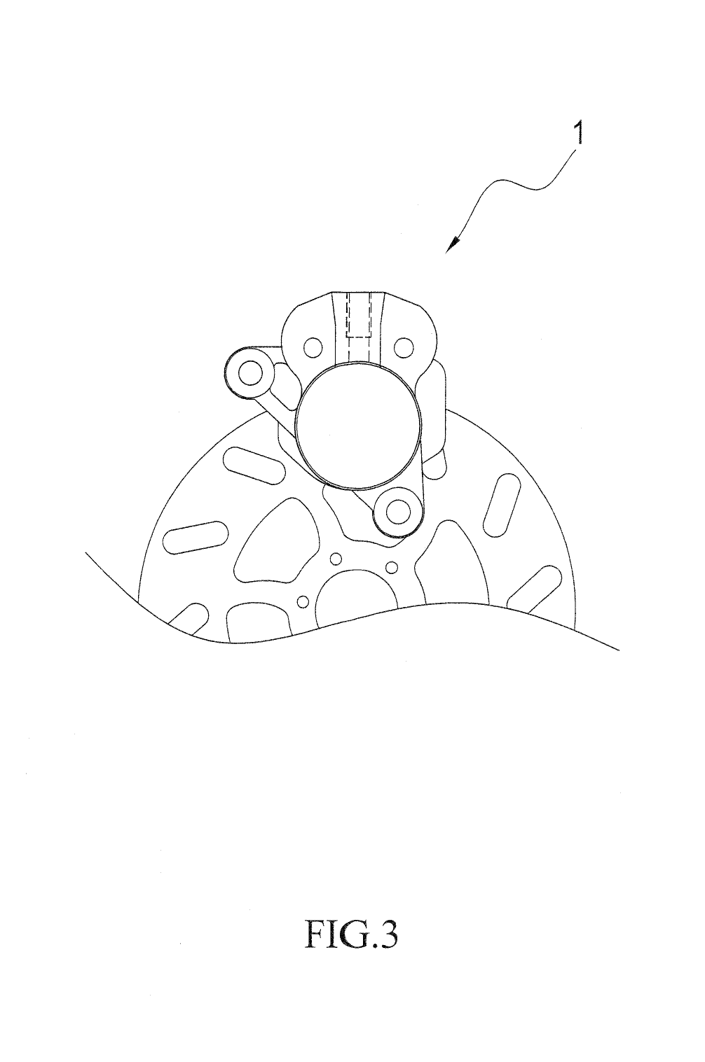

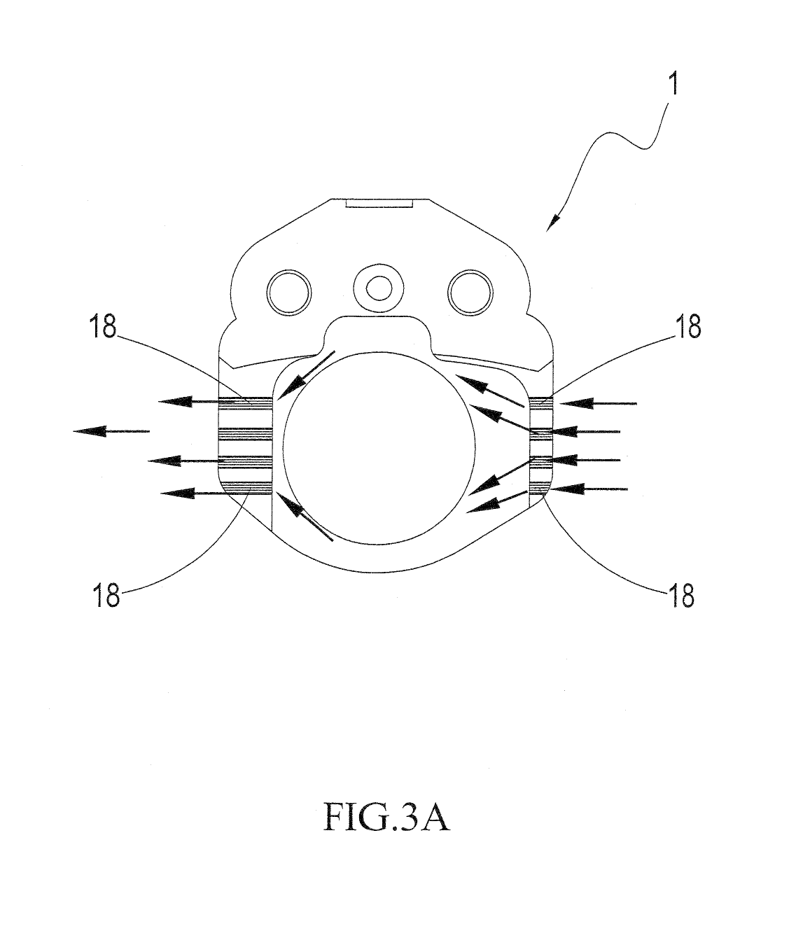

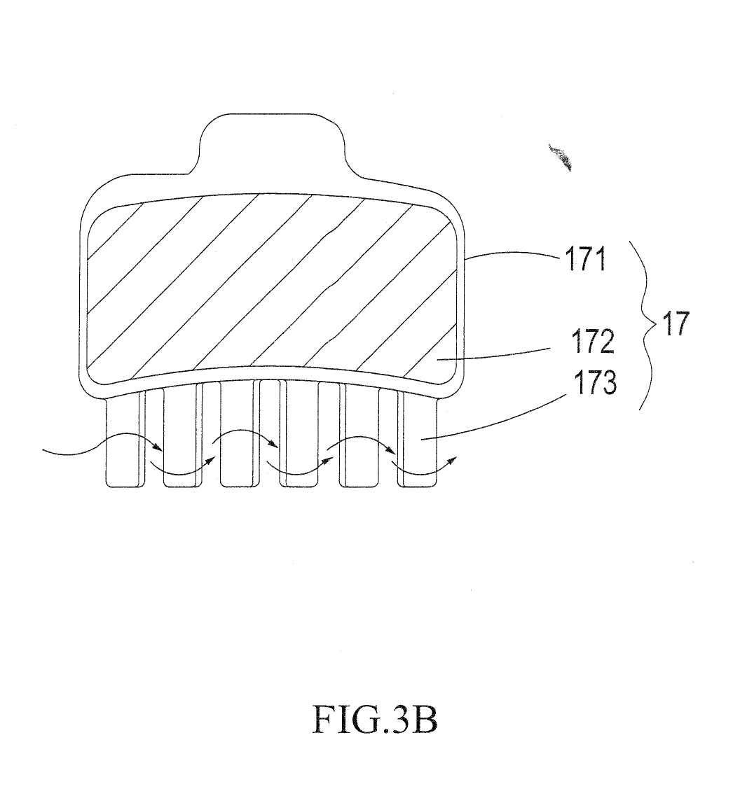

With the above arrangement, the operation of the present invention will be described as follows. Reference is made to FIGS. 2-3B, which are respectively a cross-sectional view showing a preferred embodiment of the present invention and three schematic views showing implementations of the preferred embodiment according to the present invention, these drawings clearly show that the present invention takes such an arrangement that applies a hydraulic pressures to move the elastic enclosure member 14 that forms the bent rim 141 in order to drive the brake lining assembly 17. The caliper body 1 uses the sealing bolt 12 to close and seal the fluid passages 11. In this respect, the present invention comprises a combination of the caliper body 1 and the at least one elastic enclosure member 14 that is fixed to a mounting face by the enclosure ring 13 via the sealing component 16 and the sealing ring 19 to define the pressure chamber 10 and has an outer surface to which an assembly of the magnetic permeability section 151 and the magnetic element 152 is riveted, whereby when the hydraulic fluid is increasingly fed into the pressure chamber 10 and the fluid passages 11 and the elastic enclosure member 14 depressed, the elastic enclosure member 14 becomes deformed and outward bulged and thus moves the magnetic permeability section 151 and the magnetic element 152 to drive the brake pad mounting assembly 15 and the brake lining assembly 17, wherein the brake lining assembly 17 comprise a bases 171 and a lining 172 that is movable in unison with the base 171 with the base 171 comprising a plurality of heat dissipation sections 173 extending therefrom, in order to provide a braking effect. Thus, the feature of the present invention is that an innovated structure of the elastic enclosure member 14 is provided by being made of a thin plate that is shaped in a corrugated configuration to expand the overall size of deformable body and reduce the ratio of deformation with respect to the initial size, so as to reduce the deformational stress induced in the material. The magnitude of deformational stress is proportional to the amount of deformation and the amount of deformation is determined according to the ratio of the variation of deformation with respect to the initial volume. For example, taking a bar of one meter long as an example, when one end of the bar is fixed and the opposite end is deflected by one centimeter, the stress (resistance against deformation) induced is much greater than a bar of the same material but having a length of 10 meters. Another example is given to the bar of one meter long, in which a stress is induced for deflection occurring thereon. Compared to a bar of the same material and having a length of three meters but being processed to show a corrugated configuration so as to make the final straight length of the corrugated bar, linear between two ends thereof, one meter, the stress induced in the bar of three meter long but corrugated to show a final linear length of one meter is surely lower than that of the one-meter straight bar. Based on such a principle, the present invention provides the elastic enclosure member 14 that is of low stress. Further, another feature of the present invention is that the caliper body 1 forms, at proper locations, at least one ventilation section 18, whereby external cold air is allowed to pass through the ventilation section 18 of the caliper body 1 to get into the caliper body 1, flowing over the surface of the brake pad mounting assembly 15 to remove heat generated by abrasion of the brake disk so as to effect heat dissipation.

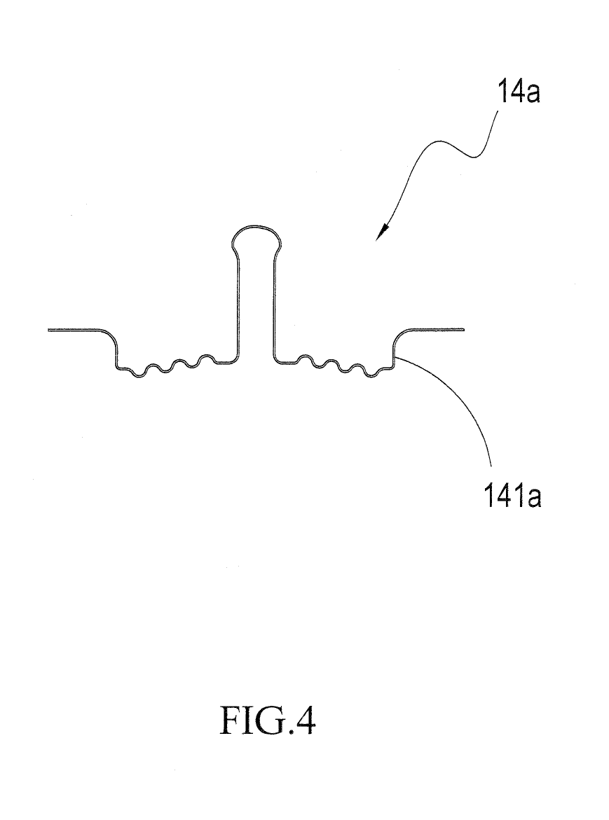

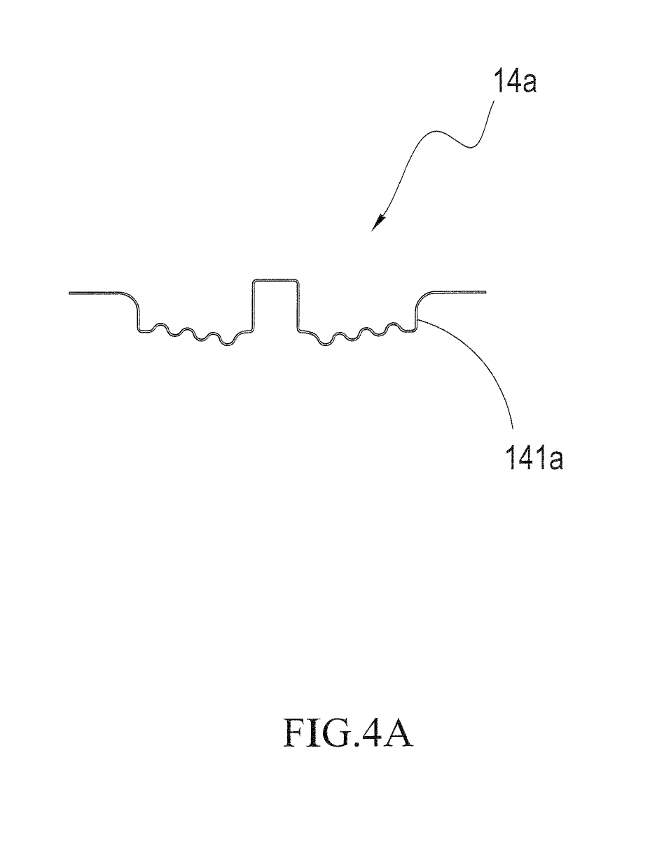

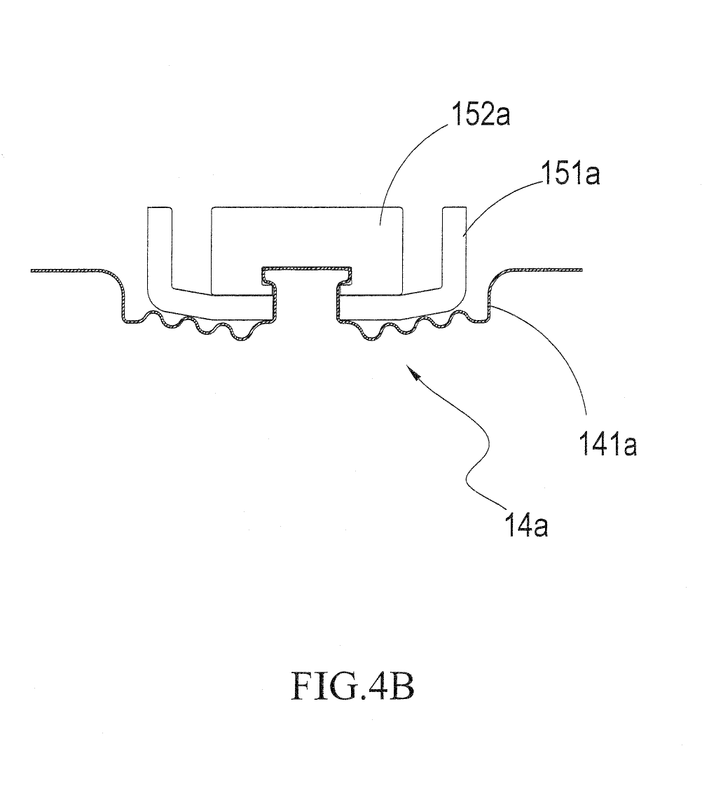

Referring FIGS. 4-4B, which are schematic views showing example implementations of another preferred embodiment according to the present invention, these drawings clearly show that the present invention provide an elastic enclosure member 14a in which the elastic enclosure member 14a defines a bent rim 141a that is coupled to the magnetic permeability section 151a and the magnetic element 152a by fitting.

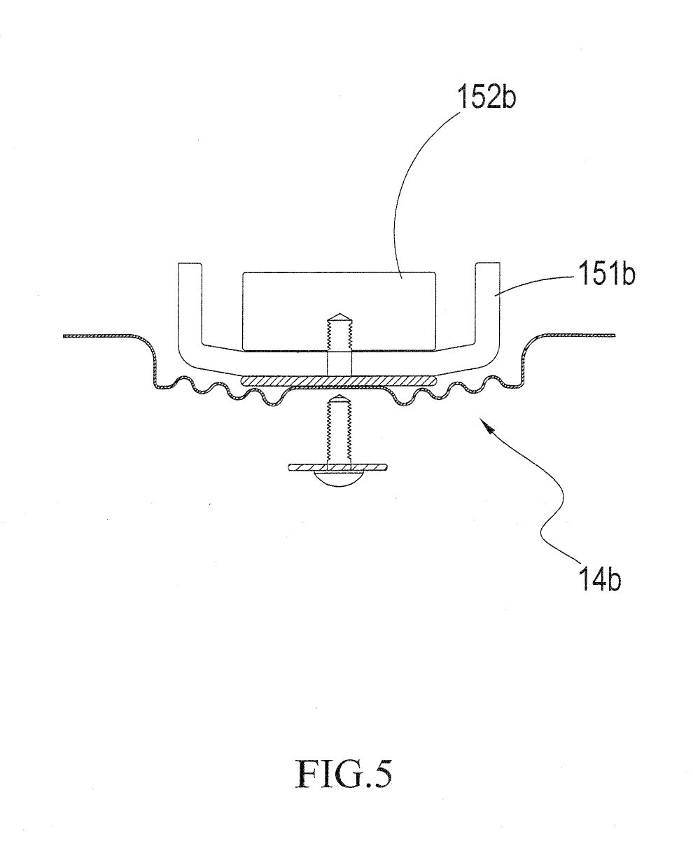

Referring to FIG. 5, which is a schematic view showing implementation of a further preferred embodiment according to the present invention, the drawing clearly shows that the present invention provides an elastic enclosure member 14b that is coupled to the magnetic permeability section 151b and the magnetic element 152b by screw fastening.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A hydraulic brake device, comprising:
at least one caliper body, which defines therein a pressure chamber;
at least one corrugated elastic enclosure member, which is arranged inside the caliper body to operate in combination with the pressure chamber; and
at least one brake pad mounting assembly, which is arranged on the elastic enclosure member at the side away from the pressure chamber.

2. The hydraulic brake device according to claim 1, wherein the caliper body comprises a threaded enclosure ring that is received therein to fix the elastic enclosure member and receives the brake pad mounting assembly therein.

3. The hydraulic brake device according to claim 2, wherein at least one sealing component is arranged at one side of the elastic enclosure member and the enclosure ring.

4. The hydraulic brake device according to claim 3, wherein the sealing component comprises a sealing adhesive or gasket.

5. The hydraulic brake device according to claim 3, wherein at least one sealing ring is arranged on the elastic enclosure member at an opposite side of the enclosure ring.

6. The hydraulic brake device according to claim 1, wherein the brake pad mounting assembly comprises a magnetic permeability section that is mounted to the elastic enclosure member and a magnetic element that is mounted to the magnetic permeability section and is operatively coupled to a brake lining assembly.

7. The hydraulic brake device according to claim 6, wherein the brake lining assembly comprises a base and a lining mounted to the base, the base comprising a plurality of heat dissipation sections extending therefrom.

8. The hydraulic brake device according to claim 1, wherein the caliper body forms at least one ventilation section.

9. The hydraulic brake device according to claim 1, wherein the elastic enclosure member is made of metal, rubber, or polymer.

10. The hydraulic brake device according to claim 1, wherein the elastic enclosure member forms a bent rim.
